(19) United States
(12) Patent Application Publication
(10) Pub. No.: US 2026/0221452 A1
(43) Pub. Date: Jul. 30, 2026

(54) AN ELECTRODE SLURRY COMPOSITION COMPRISING A SOLUTION-PROCESSED N-TYPE CONDUCTING POLYMER

(71) Applicant: WESTRA MATERIALS AB, Norrköping (SE)

(72) Inventors: Simone Fabiano, Norrköping (SE); Johannes Bintinger, Norrköping (SE); Chi-Yuan Yang, Norrköping (SE); Marc-Antoine Stoeckel, Norrköping (SE); Jun-Da Huang, Norrköping (SE); Qifan Li, Norrköping (SE)

(73) Assignee: WESTRA MATERIALS AB, Norrköping (SE)

(21) Appl. No.: 19/149,306

(22) PCT Filed: Feb. 9, 2024
(86) PCT No.: PCT/EP2024/053324

§ 371 Date: Jul. 18, 2025

(30) Foreign Application Priority Data
Feb. 10, 2023 (WO) PCT/EP2023/053385
May 17, 2023 (WO) PCT/EP2023/063322

(51) Int. Cl. H01M 4/62; H01M 4/02; H01M 4/04; H01M 4/1397; H01M 4/58; H01M 4/66; H01M 4/75; H01M 10/0568

(52) U.S. Cl. CPC H01M 4/622; H01M 4/0404; H01M 4/1397; H01M 4/5825; H01M 4/661; H01M 4/75; H01M 10/0568; H01M 2004/028

(57) ABSTRACT

The present invention relates to an electrode for use in an energy storage device, said electrode comprising an electron collector, an active material and a conductive binder, wherein said conductive binder comprises solution-processed n-type conducting polymer having a conductivity of at least 100 S/cm.

### TECHNICAL FIELD

The present invention relates to an electrode slurry composition for manufacturing an electrode for use in an energy storage device, an electrode comprising a conductive binder, and a method for manufacturing an electrode for use in an energy storage device.

### BACKGROUND OF THE INVENTION

Today, almost 100% of the cathodes of lithium-ion batteries use poly(vinylidene fluoride) (PVDF) binders. PVDF is a traditional commercial binder generally applied in lithium ferro phosphate (LFP) cathodes of lithium ion batteries (LIBs) thanks to its good electrochemical stability, relevant electrolyte absorption, adhesion ability, and high strength compared with other fluororesins.

PVDF is a unique fluororesin that shows adhesiveness to metal. This is attributed to its molecular structure in which fluorine, an electron withdrawing group, and hydrogen, an electron donating group, exist alternately.

PVDF is chemically stable by nature. It generally shows high stability to acids, water, organic solvents, oils and fats, and other chemicals. This is attributed to the strength of the C—F bonds, in which fluorine does not come off easily and is less likely to cause chemical changes. It is advantageous for the binders used in carbonate-based organic electrolytes to have low reactivity and solubility in organic solvents.

Current lithium-ion batteries are required to have an oxidation resistance above 4.6 V at the cathode and reduction resistance of up to around 0 V (against the metal potential of Li) at the anode. PVDF has both oxidation and reduction resistance properties satisfying these levels.

While general fluororesins are insoluble in organic solvents, PVDF is soluble in certain polar organic solvents such as N-methyl pyrrolidone (NMP), which enables PVDF to be coated. PVDF binders swell with general carbonate electrolytes and allow lithium-ions to pass through. Therefore, the ion diffusion resistance inside a battery is lower than that of resin binders which do not allow swelling, leading to a property in which the rate performance of the battery is less likely to drop compared with other resins. If the amount of swelling of an electrolyte is very small, the binder becomes a large resistive component in a battery. The appropriate degree of swelling as a binder is considered to be about 20 to 40%.

Despite all the above-mentioned advantages, PVDF suffers from certain drawbacks. First of all, the non-polar structure of PVDF is only able to form weak intermolecular interactions with active materials and current collectors. Therefore, over repeated charge/discharge cycles, the homogeneous composite structure of the pristine electrode is disrupted due to substantial volume changes, leading to mechanical failure and capacity decay. Secondly, the electrically insulating nature of PVDF requires the addition of carbon additives to boost the electrical conductivity of electrodes. In traditional Li-ion batteries, carbon additives are essential for providing electron-conducting networks within battery electrodes. However, carbon additives tend to agglomerate, which increases internal resistance. Furthermore, since the PVDF/C mixture exhibits little capacity on its own, adding carbon additives reduces the overall battery energy density. Lastly, the environmental concern of using volatile and toxic NMP solvent during the casting process of PVDF/C/active-material electrodes also needs to be considered. Therefore, tremendous efforts have been devoted to finding improved alternative binders that can be applied for high energy density batteries.

Among such material, sodium carboxymethyl cellulose (CMC), sodium carboxymethyl chitosan (CCTS), sodium alginate (SA), styrene-butadiene rubber (SBR), or polytetrafluoroethylene (PTFE) may be mentioned. Many of these binders exhibit strong polar interactions, even hydrogen bonds, with the surfaces of cathode intercalation and anode conversion materials, due to the presence of hydroxyl and carbonyl groups. This same chemistry makes them also more easily dispersed in polar solvents, allowing for aqueous processing. Just as other standard binders, these polymers are insulating, necessitating the addition of carbon powders.

Consequently, polymer binders are no longer regarded only as merely bond reagents but also as contributors to the conductivity and the solid electrolyte interphase (SEI) stabilization of anodes/cathodes. Outstanding binders should provide powerful binding affinities between the active material particles and the current collectors to maintain electrode integrity, even under limited ion diffusion and side reactions. In the process of slurry preparation, polymer chains coat LFP particle surfaces upon stirring. Next, the produced slurry is coated onto aluminium foils, and electrodes are created upon drying. Therefore, the polymer structure coated onto the LFP particle surface significantly affects the performance of electrodes. Efficient polymer structures could promote the diffusion of Li⁺ to a degree which would be helpful for mitigating the shortage of one-dimensional Li⁺ channels in LFP materials.

Consequently, binders of LIBs have been increasingly investigated over the years to provide novel concepts for designing new polymer structures. As a result, polymer binders have become strategic components for alleviating the cyclability problems of batteries. In this regard, an ideal electrode model should be able to fulfil several aspects. The first consists of maintaining enough adhesion to prevent delamination and separation of electrodes during charge/discharge processes. The second relies on compatibility with slurry preparation and electrode fabrication in addition to offering continuous conductive networks within electrodes. This also facilitates the formation of electron and ion circuits to maintain the transfer of Li⁺ and guarantee effective electrochemical reactions. On the other hand, providing electrochemical, chemical, and thermal stability under severe internal and external battery environments is also important. Finally, cost efficiency of widescale commercial application is highly desirable. For LFP materials, three major strategies have been utilized for binder development. The first consists of a traditional polyvinylidene fluoride (PVDF) binder used for commercial applications. The second consists of waterborne binders with eco-environmental properties. The third relies on functional binders such as the conductive or ionomer polymers used to overcome shortages of LFP structures. The use of efficient binders in LFP cathodes could enhance conductivity and promote ion diffusion, thereby improving their properties and long-term cycle life.

CPs exhibit a backbone with an extended pi-electron network. Undoped CPs are semiconductors. However, upon doping, the electrical conductivity of CP changes significantly to intrinsic electron conduction. Dopants are oxidizing or reducing the polymer chain backbone which creates charge carriers within the extended pi-electron network. Even though CPs have been widely used in many industrial applications, the use of CPs as binders for lithium-ion batteries has been restricted because of difficulties in their processing. These polymers exhibit low thermal stability, making melt processing difficult, and few CPs can be directly dispersed in solvents for solution processing.

Among polymers, poly(3,4-ethylenedioxythiophene):polystyrene sulfonate (PEDOT:PSS) with high conductivity was explored as a binder for LFP cathodes. The obtained electrodes displayed rate performances with a capacity of 126 mAh g-1 at 5 C as well as cycling stability at 1 C with less than 1% decay after 100 cycles. Although these values exceeded those of LFP cathodes fabricated with conventional compositions, PEDOT:PSS binder suffers from numerous drawbacks. First of all, PEDOT:PSS has a limited thermal stability of only up to 150° C. Further, PEDOT:PSS is rather expensive material, which indeed adds to the final cost of the energy storage device. Another disadvantage of PEDOT:PSS is that this material is PEDOT:PSS is water-based, since in some application it might be beneficial to use water-free compositions. Moreover, PEDOT:PSS is rather acidic with pH around 1-3; which could potentially lead to corrosion or degradation of the electrodes over time, affecting the battery's lifespan and performance. Given the fact that PEDOT:PSS is a p-type material, this may lead to poor efficiency of charge collection and considerable energy losses. Yet another drawback of PEDOT:PSS is its rather poor conductivity and mechanical stability.

Therefore, there is a need for an improved conductive binder material that eliminates the need for conductive additive, which is readily processable in solution using environmentally friendly solvents, and that provides superior structural integrity of the electrode.

### SUMMARY OF THE INVENTION

Considering the above, the present invention aims to solve the problems of the prior art. To this end, the present invention relates to an electrode slurry composition for manufacturing an electrode for use in an energy storage device. By the term “electrode” is meant an electrical conductor used to make contact with a non-metallic part of a circuit. By the term “energy storage device” is understood a device which accepts energy, stores energy, and releases energy as needed. In particular, the term “energy storage device” as used in the context of the present invention is intended to imply a secondary cell, also referred to as a rechargeable battery. Such an energy storage device may be charged, discharged into a load, and recharged many times through a reversible electrochemical reaction, as opposed to a disposable or primary battery. The energy storage device according to the present invention may be of any size and shape, ranging from button cells to megawatt systems. Several different combinations of electrode materials and electrolytes may be used in the energy storage device of the present invention, including lead-acid, zinc-air, nickel-cadmium (NiCd), nickel-metal hydride (NiMH), lithium-ion (Li-ion), lithium iron phosphate (LiFePO4), and lithium-ion polymer (Li-ion polymer). In particular, the energy storage device according to the present invention may be a Li-ion battery. Such a battery uses lithium ions as the solute in the electrolyte which are dissolved in an organic solvent.

According to the present invention, the electrode slurry composition comprises an active material and a conductive binder, wherein the conductive binder comprises a solution-processed n-type conducting polymer having conductivity of at least 100 S/cm, preferably at least 500 S/cm.

The n-type conducting polymer may be side-chain free. The term “side-chain free” is in the context of the present invention intended to mean that only one carbon atom is extending from the conjugated backbone system of the polymer. Such an embodiment offers the advantage of an improved interface to the nanoparticles of the active material and/or surfaces of the electron collector, since side chains introduce some distance between the rr-system of the polymer and the surface of the electron collector, which in turn can decrease the charge transfer. Further, the solution-processed n-type conducting polymer may comprise a repeating unit comprising a central symmetrical benzene ring as the skeleton, active hydrogen and at least one electron-withdrawing group at the benzylic position. In particular, the solution-processed n-type conducting polymer may be poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P) or a mixture thereof, as depicted below. The structure of PDADF-P is similar to the structure of PDADF, but lack heterocyclic segments.

Such a solution-processed n-type conducting polymer may have thermal stability up to 225° C., as will be described in greater detail below.

As mentioned above, the monomer may have the central symmetrical benzene ring as the skeleton, active hydrogen and at least one electron-withdrawing group at the benzylic position. The electron-withdrawing groups may be carbonyl, carboxyl, amide, alkoxy acyl or the like.

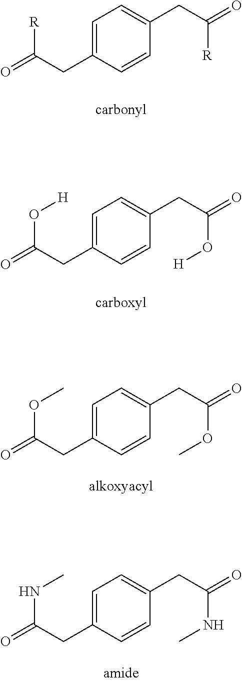

Further, the monomer may be in the form of a heterocyclic moiety having a central symmetrical benzene ring fused with at least one, preferably at least two rings, preferably five-membered rings. The monomer further comprises an active hydrogen and at least one electron-withdrawing group at the benzylic position. In particular, the monomer may be 3,7-dihydrobenzo[1,2-b:4,5-b′]difuran-2,6-dione (HBFDO), 5,7-dihydropyrrolo[2,3-f]indole-2,6(1H,3H)-dione, or 3,7-dihydrobenzo[1,2-b:4,5-b′]dithiophene-2,6-dione.

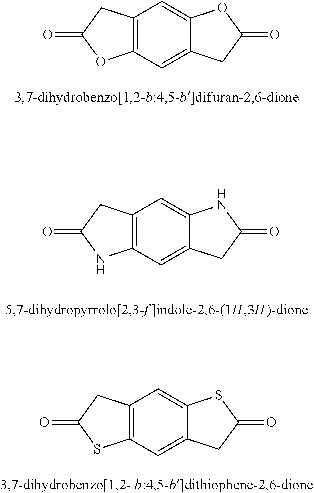 [SMILES: O=C1Cc2cc3c(cc2O1)CC(=O)O3 ; O=C1Cc2cc3c(cc2N1)CC(=O)N3 ; O=C1Cc2cc3c(cc2S1)CC(=O)S3]

In particular, the monomer may be 3,7-dihydrobenzo[1,2-b:4,5-b]difuran-2,6-dione (HBFDO). In such an embodiment, the n-type conducting polymer may be poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P) or a mixture thereof, as depicted below. In PDADF, m and n are integers that may be same or different.

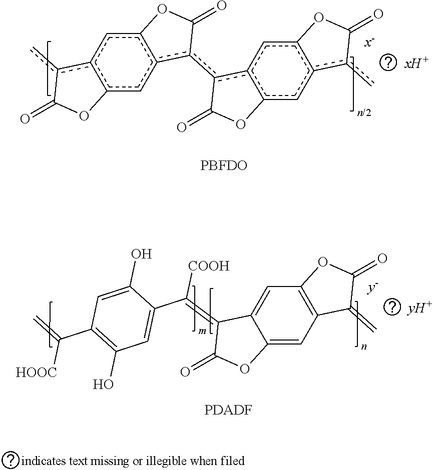

The solution-processed n-type conducting polymer used in the electrode slurry composition according to the present invention may be manufactured from an ink comprising the solution-processed n-type conducting polymer and a solvent system. The solvent system may comprise a polar aprotic solvent and/or a polar protic solvent.

In particular, the polar aprotic solvent may be selected from DMF, DMSO, and combinations thereof. The polar protic solvent may be selected from water, ethanol, propanol, butanol and combinations thereof.

The active material present in the electrode slurry composition according to the present invention depends on which type of electrode is to be manufactured.

When the electrode slurry composition is to be used for manufacturing a cathode, the active material may be selected from Li-based layered transition metal oxides (and Li-based metal chalcogenides or Li-rich layered metal oxides and Ni-rich layered metal oxides), spinel oxides, polyanion compounds (LiFePO₄, LiMnPO₄, Li₂MnSiO₄, LiCoSiO₄, etc.) and conversion-type cathode materials (e.g. transition metal halides, metal oxides, Li₂S, etc.). In particular, the active material may be lithium iron phosphate (LiFePO₄). Further, the active material may be selected from the group consisting of lithium nickel manganese cobalt oxide (NMC, LiNiMnCoO₂), lithium cobalt oxide (LCO, LiCoO₂), lithium nickel cobalt aluminium oxide (NCA, LiNiCoAlO₂), lithium manganese oxide (LMO, LiMn₂O₄).

It is further feasible that the active material for cathode is selected form the group consisting of Na-based layered oxides, such as sodium cobalt oxide (NaCoO₂) and sodium nickel oxide (NaNiO₂). These layered oxides can facilitate the intercalation of sodium ions. Another suitable cathode active material is a transition metal hexacyanoferrate, or a polyanionic compound, such as sodium iron phosphate (NaFePO₄) and Na₃V₂(PO₄)₂F₃. These materials are known for their stability and safety.

If the electrode slurry composition of the present invention is intended to be used for manufacturing an anode, the active material may be selected from the group consisting of graphite, a silicone-based material or titanate (Li₄Ti₅O₁₂ or Na₂Ti₃O₇). The most common anode material is graphite, valued for its stability and ability to intercalate lithium ions during the charging process. Lithium titanate (Li₄Ti₅O₁₂) is known for its fast charging capabilities and excellent safety, but it has a lower energy density. Silicon and in particular silicon nanoparticles offer a much higher capacity than graphite but faces challenges in terms of volume expansion during lithium intercalation, leading to potential structural degradation. Alternatively, the anode active material may be in the form of hard carbon or a metallic alloy comprising Sn or Sb.

The active material may be present in an amount of from 50 to 98 wt % of the total weight of the electrode slurry composition. In particular, the active material may be present in an amount of from 90 to 98 wt %.

The conductive binder may be present in the amount from 0.1 to 25 wt %, preferably from 0.2 to 10 wt %, most preferably from 0.5 to 5 wt % of the total weight of the electrode slurry composition.

The electrode slurry composition may have a solid content of from 10 to 50%. In particular, the solid content of the electrode slurry composition may be from 30 to 50%. It is beneficial that the electrode slurry composition has as high solid content as possible.

It has been shown that the conductivity of a solution-processed n-type conducting polymer is much higher than e.g. in situ polymerized PEDOT:PSS. Further, the solution-processed n-type conducting polymer is fluorine-free (compared to PVDF) and does not require toxic solvents like 1-Methylpyrrolidin-2-one (NMP). Finally, the solution-processed n-type conducting polymer has improved mechanical stability and thermal resistance of up to 225° C. at 1000 h compared to previously known binder materials, such as PEDOT:PSS, which is important for maintaining electrode integrity during the repeated charge-discharge cycles.

Since the solution-processed n-type conducting polymer is preferably side-chain free, it can be doped by protons from the nanoparticle surface of the active material, thus providing a dual effect, i.e. enhanced conductivity due to doping along with improved coverage of the active material nanoparticles and beneficial binding to the surface of the electron collector.

The electrode slurry composition as described above may be used for manufacturing an electrode of an energy storage device. Thus, the present invention relates to an electrode for use in an energy storage device. Such an electrode comprises an electron collector, an active material and a conductive binder. The conductive binder comprises solution-processed n-type conducting polymer having a conductivity of at least 100 S/cm, preferably at least 500 S/cm.

It should be stressed that the electrode according to the present invention may be either a cathode or an anode.

In particular, the n-type conducting polymer may be side-chain free. It should be noted that the n-type conducting polymer present in the electrode slurry composition may comprise side chains, while the same n-type conducting polymer present in the electrode may be side-chain free, since the side chains may be removed during annealing of the electrode slurry composition. On the other hand, if the n-type conducting polymer present in the electrode slurry composition is side-chain free, than the same n-type conducting polymer present in the electrode will indeed be side-chain free as well. Further, the solution-processed n-type conducting polymer may comprise a repeating unit comprising a central symmetrical benzene ring as the skeleton, active hydrogen and at least one electron-withdrawing group at the benzylic position.

As mentioned above, the solution-processed n-type conducting polymer may be poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P) or a mixture thereof.

When the electrode of the present invention is intended to be used as a cathode, said active material is selected from the group consisting of: LiVOPO₄, LiCoO₂, LiNiO₂, LiNi₁₋ₙCoₙO₂, LiNi₁₋ₙ₋ₘCOₙAlₘO₂, LiNi₁₋ₙ₋ₘCOₙMnₘO₂, LiMn₂O₄, LiFePO₄ and LiFe₁₋ₙMnₙPO₄, LiCoPO₄, Li₂FeP₂O₇, Li₂FeSiO₄ and combinations thereof. In particular, the active material may be lithium iron phosphate (LiFePO₄).

The electron collector may be a metal selected from a group consisting of aluminium (AI), titanium (Ti), copper (Cu) and combinations thereof. In particular, the electron collector may be aluminium foil.

The electrode may further comprise a dispersant and/or a non-conductive binder. The dispersant improves dispersibility and the rheology of the slurry, while non-conductive binders improve the structural integrity and provide mechanical support.

The thickness of the conductive binder and the active material on the electron collector may be from 5 μm to 500 μm, preferably from 10 μm to 300 μm, most preferably from 20 μm to 200 μm.

Since the solution-processed n-type conducting polymer is preferably side-chain free, it can be doped by protons from the surface of the nanoparticles of the active material, thus providing a dual effect, i.e. enhanced conductivity due to doping along with improved coverage of the active material nanoparticles and beneficial binding to the surface of the electron collector.

The present invention also relates to an energy storage device comprising an electrode as described above. In particular, the electrode disclosed above functions as a cathode.

The energy storage device according to the present invention may further comprise LiPF₆ as electrolyte solution and an anode comprising an alkali metal.

The energy storage device may be of any kind known in the art, such as a coin cell, a pouch cell, a cylindrical battery or a battery pack. The energy storage device of the present invention may be used in a wide variety of applications, such as electronics or automotive industry.

Finally, the present invention relates to a method for manufacturing an electrode for use in an energy storage device. Such a method comprises the steps of:
a) mixing an active material with a dispersion solution comprising a conductive binder comprising a solution-processed n-type conducting polymer having conductivity of at least 100 S/cm, preferably at least 500 S/cm, thus obtaining a slurry;
b) applying the slurry onto an electron collector thus obtaining the electrode;
c) drying the electrode.

The solution-processed n-type conducting polymer present in the dispersion solution mentioned above may be in the form of micelles having a diameter lower than 1 μm, preferably lower than 0.5 μm, more preferably lower than 0.2 μm. The particle size may easily be verified by filtration of the polymer solution through a 0.2 μm or 0.45 μm PE, Teflon or PTFE filters, whereupon it may be observed that the solution remains coloured, thus indicating that the polymer micelles pass through the filter.
Step b) may be performed by any means conventionally used in the art. In particular, step b) may be performed by means of bar coating. Alternatively, step b) may be performed by calendering.
Step c) may be performed at the temperature of from 100° C. to 200° C. and for a period of time from 30 min to 2 h. Step c) may be performed under dynamic vacuum.

The method described above may further comprise the step of:
d) homogenizing the slurry;
wherein the step d) occurs before step b).

Such a step d) may be performed for a period of time from 1 min to 1 h at 4000-10000 rpm.

### BRIEF DESCRIPTION OF THE DRAWINGS

Embodiments of the invention will now be described by way of example with reference to the accompanying drawings, of which:

FIG. 1 shows morphology of the reference benchmark LFP electrode;

FIG. 2 depicts morphology of the n-LFP electrode according to the present invention;

FIGS. 3a and 3b show the results of electrochemical stability of the electrode according to the present invention;

FIG. 4 depicts performance of electrode of the present invention versus the reference electrode during one charge-discharge cycle at 0.2 C;

FIG. 5 illustrates performance of the electrode of the present invention during 3 charge-discharge cycles at 0.2 C;

FIGS. 6a-6c show the result of reproducibility evaluation of the electrode of the present invention;

FIG. 7 depicts Coulombic efficiency and specific discharge capacity of the electrode according to the present invention compared to the reference electrode.

FIGS. 8a-8c depict thermal stability of the solution processed n-type conducting polymer used in the electrode according to the present invention.

### DETAILED DESCRIPTION OF THE INVENTION

As mentioned above, the present invention provides an electrode slurry composition for manufacturing an electrode for use in an energy storage device, wherein the electrode slurry composition comprises an active material and a conductive binder, wherein the conductive binder comprises a solution-processed n-type conducting polymer having conductivity of at least 100 S/cm. The inventors surprisingly found that the n-type conducting polymer present in the electrode slurry composition according to the present invention acts both as a binder and conductive additive, thus eliminating the need for a conductive additive. The electrode slurry composition according to the present invention may be prepared using more environmentally friendly solvents compared to conventional compositions. The n-type conducting polymer offers a per- and polyfluoroalkyl substances (PFAS)-free alternative to the PVDF binder commonly used in battery slurries.

These and other advantages of the present invention will be described in detail below.

In order to evaluate the electrode slurry composition as well as the electrode of the present invention, a reference electrode, also referred to as LFP electrode, and an inventive electrode, also referred to as n-LFP electrode, were prepared.

The electrode slurry composition for the reference electrode was manufactured by dissolving PVDF 5130 (5 wt %) in DMSO using stirring. In order to completely dissolve PVDF in DMSO, the solution was heated up to 70° C. The active material in the form of LFP (90 wt %) and the conductive additive in the form of carbon black (5 wt %) were added to the PVDF dispersion solution, followed by homogenization in an Ultraturrax T25 homogenizer for 5 mins at 3000 rpm. The reference electrode was manufactured by bar coating the electrode slurry on aluminium foil at a casting thickness of 50 μm. The resulting reference electrode was dried at 120° C. for 2 h under dynamic vacuum.

The electrode slurry composition of the present invention was manufactured as follows. LFP active material was mixed with conductive binder in the form of PBFDO dispersion in DMSO obtained from n-ink (1.56 wt %, N43, batch 20231123) such that the wt % ratio of active material to the conductive binder is 95:5.

The resulting electrode slurry composition was loaded into Ultraturrax T25 homogenizer and mixing was done for 20 min at 6000-8000 rpm.

Al foil was coated by the homogenized electrode slurry composition at 60 μm casting thickness this resulting in electrode blanks. The blanks were dried at 120° C. for 2 h under dynamic vacuum.

The electrode composition for the reference electrode and for the electrode of the present invention is summarized in Table 1.

TABLE 1
Electrode composition

| | | Conductive | | | | Casting | |
|---|---|---|---|---|---|---|---|
| | Active material | additive | Binder | Solid content | Casting | thickness | |
| Electrode | (wt %) | (wt %) | (wt %) | in slurry (%) | method | (μm) | Drying conditions |
| LFP | LiFePO₄ (90) | Carbon | PVDF (5) | 40.82 | Bar coating | 50 | 120° C., 2 h, vacuum |
| | | black (5) | | | | | |
| n-LFP | LiFePO₄ (95) | — | N43 (5) | 23.5 | Bar coating | 60 | 120° C., 2 h, vacuum |

Circular electrodes with diameter 11 mm were punched from each of the dried electrode blanks. LFP electrodes had thickness of 12±1 μm and weight of 1.7±1 mg, n-LFP electrodes had thickness of 14±1 μm and weight of 2.1±1 mg.

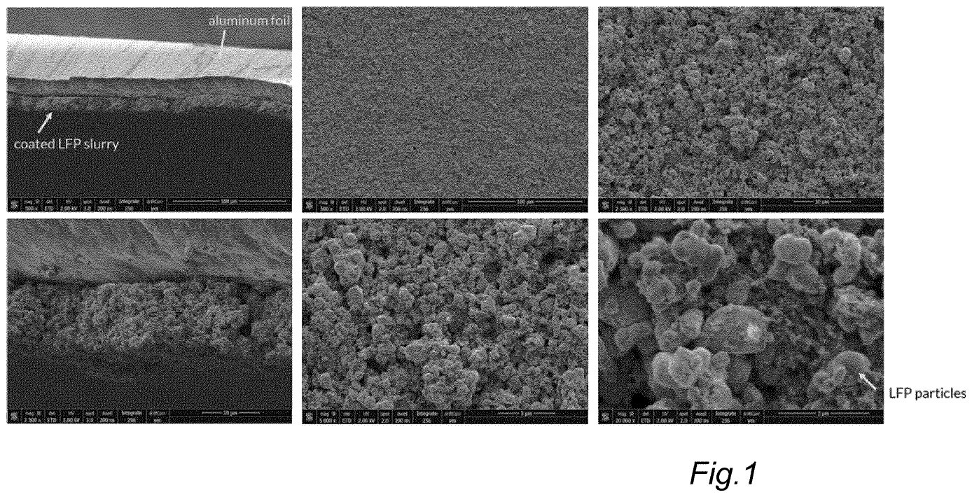

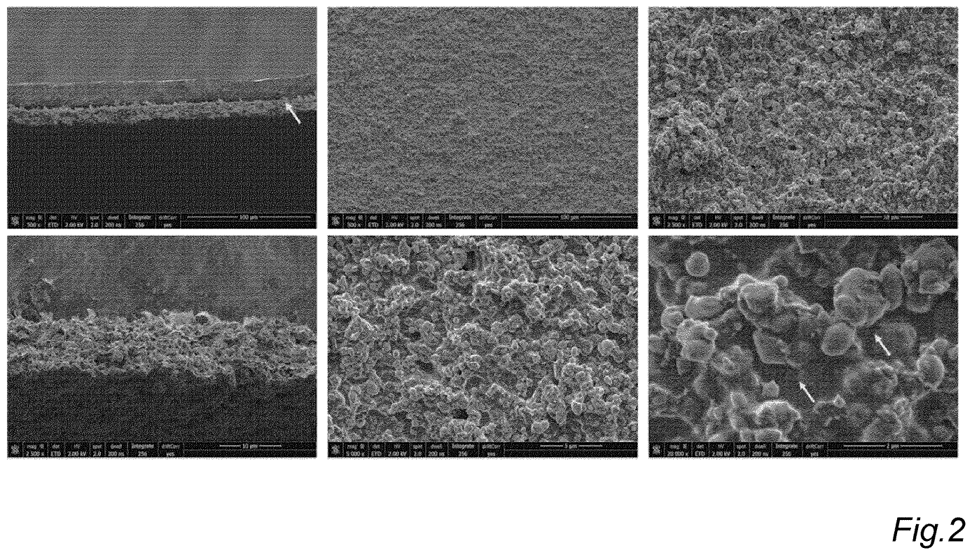

FIGS. 1 and 2 illustrate SEM images of the reference electrode and the electrode of the present invention, respectively. As may be seen in FIG. 2, favourable interface between the aluminium foil and the coated n-LFP slurry is formed. Besides, uniform coating of the LFP particles by N43 is obtained, since a smooth matrix surrounding the LFP particles may be seen. Further, N43 acts as a binder for the LFP particles.

In order to investigate the electrochemical stability and performance of the energy storage devices according to the present invention, coin cells were assembled in Ar filled glove box, using 1M LiPF₆ electrolyte solution in carbonate solvent, separator, and metallic Li counter electrodes. Coin cells were prepared both for the n-LFP and LFP electrodes. Three cells were assembled per electrode type for electrochemical testing, these will be referred to as LFP-S1, LFP-S2, LFP-S3, and n-LFP-S1, n-LFP-S2, n-LFP-S3, respectively.

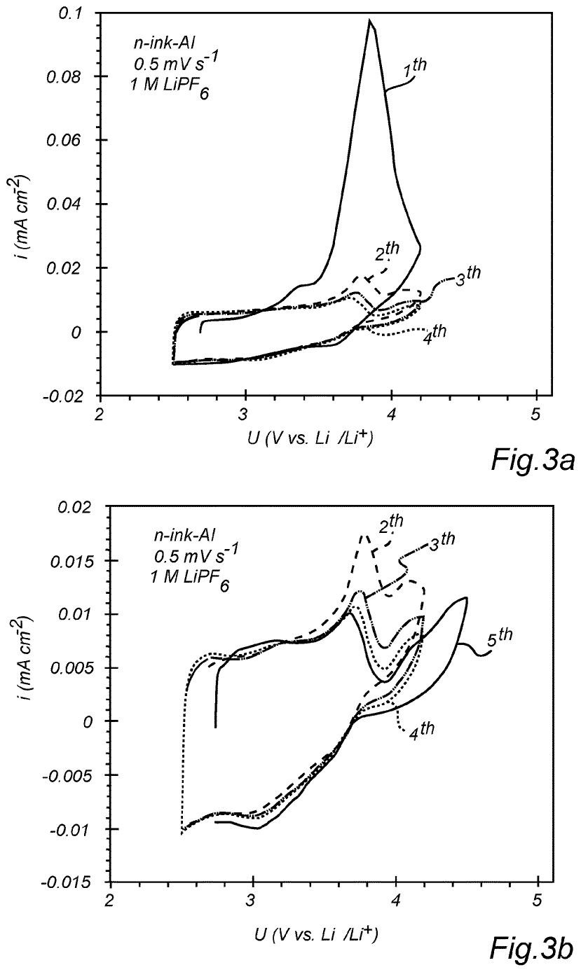

Cyclic voltammetry (CV) at 0.5 mV s-1 was used to experimentally evaluate the electrochemical stability of N43 spin-coated onto aluminium foil. The results are summarized in FIGS. 3a and 3b.

The CV of N43 film between 2.5 to 4.5 V demonstrates that it does not show irreversible oxidation or reduction, except in the first cycle (FIG. 3a). This means that N43 does not degrade in this voltage operating window. This is a promising result indicating the potential use of the conductive binder of the present invention in most of the cathodes, including NMC systems.

As may be seen in FIGS. 3a and 3b, n-LFP is stable at 4.2 V vs. Li+/Li. Even expanding the potential window to 4.5 V vs. Li+/Li showed stable behaviour. Moreover, the conductive binder according of the present invention has a favourable capacitive contribution.

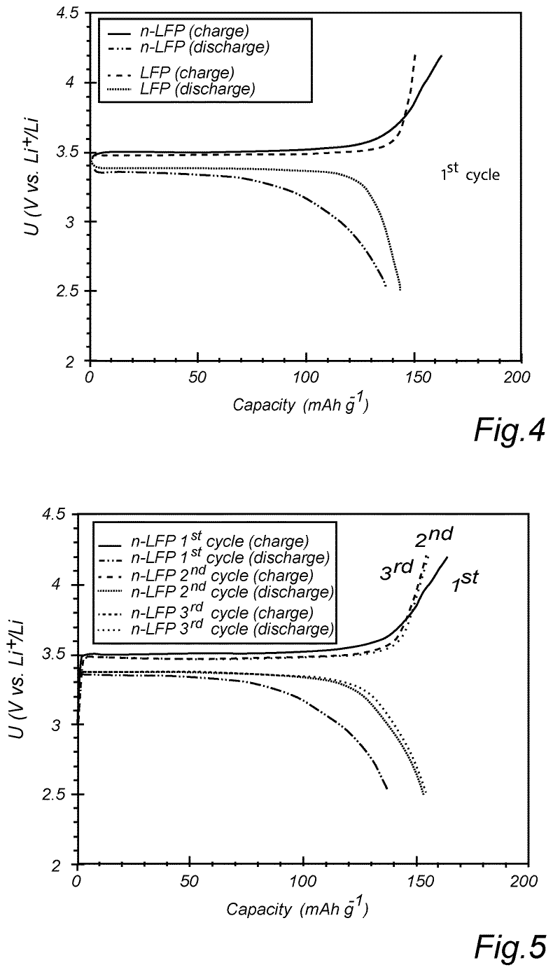

The electrochemical performance of the energy storage device according to the present invention was evaluated at a rate of 0.2 C. The charge and discharge curves (first cycle) for n-LFP and LFP electrodes are shown in FIG. 4.

The faradaic Li-extraction from LFP cathode occurs during the charging process (solid-like) around 3.5 V which shows a linear change in capacity. After this process, a small portion (less than 10%) of capacitive charge storage takes place up to 4.2 V. During the discharge process, the faradaic lithiation reaction occurs to the cathode around 3.4 V and after that a small amount of capacitive discharge up to 2.5 V.

As may be seen in FIG. 4, impressive performance for the 1st cycle of galvanostatic charge-discharge at 0.2 C is seen for the electrode of the present invention. High-capacity value indicates that the capacity of n-LFP electrode is close to the practical capacity of LFP electrode (150 mAh/g). Further, it is proven that N43 can work as both binder and conductive additive.

The electrochemical performance of the energy storage device of the present invention during cycling (charge-discharge) was evaluated by measuring the variations of the capacity with the variation of the voltage (U) at a rate of 0.2 C. The charge and discharge cycles are shown in FIG. 5. As may be seen in FIG. 5, similar behaviour for different cycles is observed, indicating the stability of electrochemical behaviour. Further, capacity increases during the first few cycles, indicating improved wetting of the electrodes.

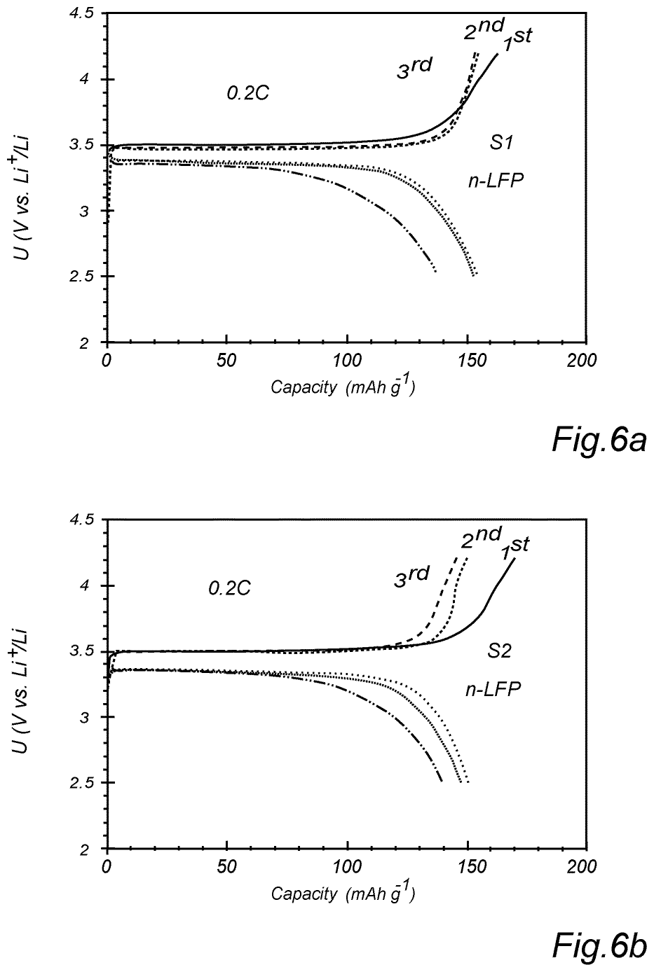

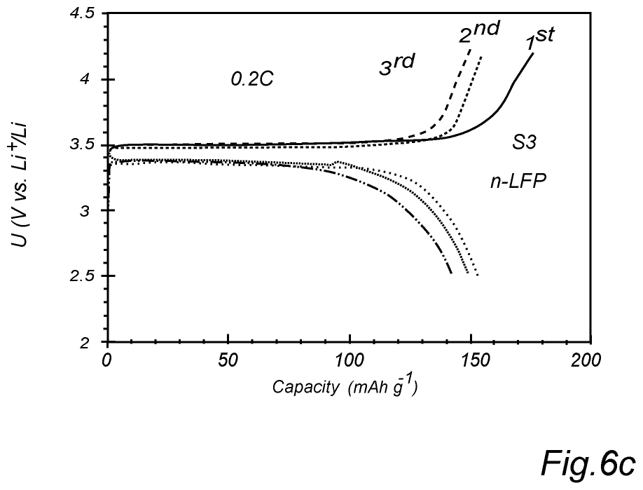

Next, reproducibility evaluation was performed for the three cells comprising n-LFP electrodes, as may be seen in FIGS. 6a-6c. The results are reproducible, exhibiting similar results from the three different cells. Also, similar behaviour for different cycles is observed, indicating the stability of electrochemical behaviour. Even here it is seen that capacity increases during the first few cycles, indicating improved wetting of the electrodes.

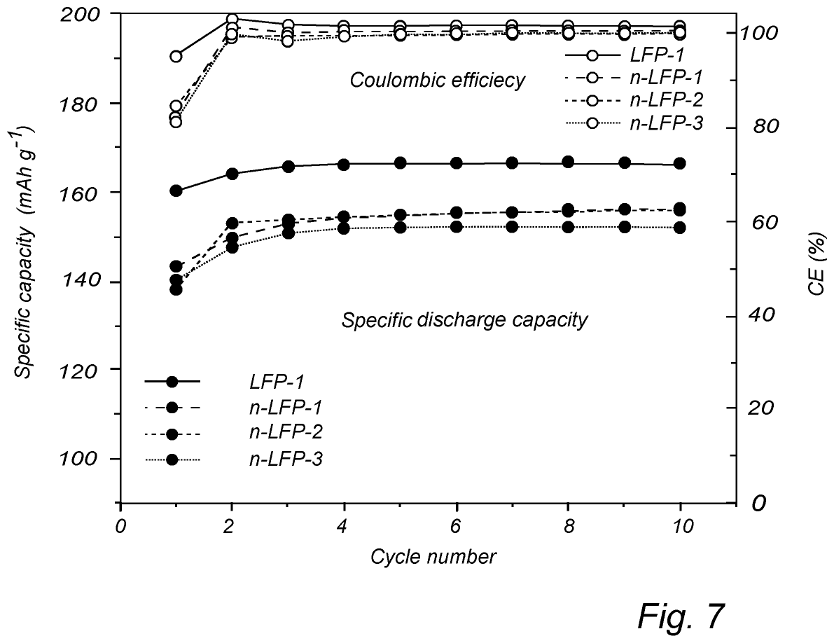

Electrochemical performance stability over 10 cycles was evaluated for energy storage devices comprising LFP vs n-LFP electrodes, respectively. Specific discharge capacity and Coulombic efficiency were measured. The results are shown in FIG. 7. As may be seen, stable electrochemical behaviour is seen for three different n-LFP samples over 10 cycles. Coulombic efficiency is approaching 100% reflecting the high reversibility and absence of parasitic reaction.

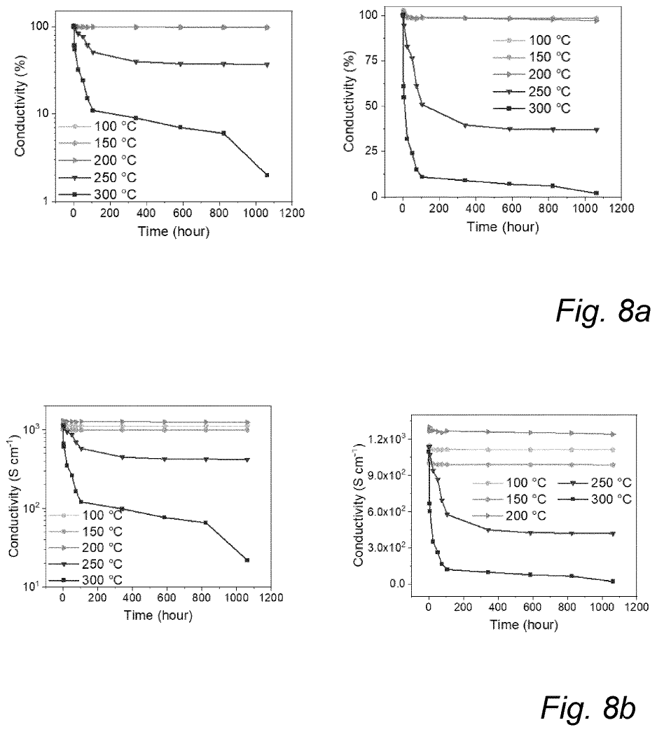

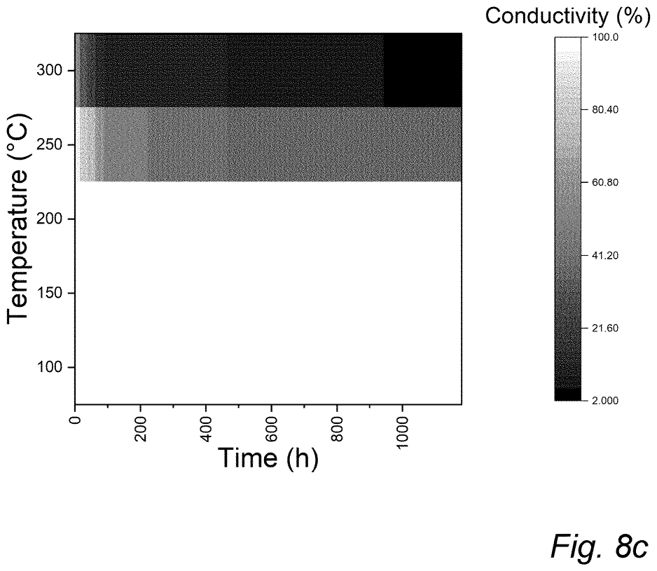

FIGS. 8a and 8b illustrates thermal stability of the solution-processed n-type conducting polymer used in the electrode of the present invention, i.e. poly(benzodifurandione) (PBFDO). As may be seen, PBFDO shows remarkable thermal stability with virtually no drop in conductivity up to 200° C. The solution-processed n-type conducting polymer may thus be heat resistant up to 225° C., as confirmed in FIG. 8c. By the term “heat resistant” is meant that the solution-processed n-type conducting polymer keeps its conductivity in a film up to 225° C.

To summarize, it has been shown that the electrode slurry composition of the present invention eliminated the need for conductive additives, and may be produced using more environmentally friendly solvents, e.g. DMSO, instead of commonly used NMP, and without the use of PFAS. Further, n-LFP electrodes show a uniform distribution of the conductive binder coating on LFP particles. The capacity value of the electrodes of the present invention is very promising and close to the practical capacity of LFP (150 mAh/g). The results are reproducible, with nearly the same results from different three cells. The electrodes of the present invention exhibit stable electrochemical behaviour for the different n-LFP samples over 10 cycles. Further, Coulombic efficiency of the electrodes of the present invention approaches 100%, thus reflecting the high reversibility.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

1. An electrode for use in an energy storage device, said electrode comprising an electron collector, an active material and a conductive binder, wherein said conductive binder comprises solution-processed n-type conducting polymer having a conductivity of at least 100 S/cm.

2. The electrode according to claim 1, wherein said n-type conducting polymer is side-chain free.

3. The electrode according to claim 1 or 2, wherein said solution-processed n-type conducting polymer has thermal stability up to 225° C.

4. The electrode according to any one of the preceding claims, wherein said solution-processed n-type conducting polymer comprises a repeating unit comprising a central symmetrical benzene ring as the skeleton, active hydrogen and at least one electron-withdrawing group at the benzylic position.

5. The electrode according to any one of the preceding claims, wherein said solution-processed n-type conducting polymer is poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P) or a mixture thereof.

6. The electrode according to any one of the preceding claims, wherein said active material is selected from the group consisting of: LiVOPO₄, LiCoO₂, LiNiO₂, LiNi₁₋ₙCOₙO₂, LiNi₁₋ₙ₋ₘCOₙAlₘO₂, LiNi₁₋ₙ₋ₘCOₙMnₘO₂, LiMn₂O₄, LiFePO₄ and LiFe₁₋ₙMnₙPO₄, LiCoPO₄, Li₂FeP₂O₇, Li₂FeSiO₄ and combinations thereof.

7. The electrode according to any one of the preceding claims, wherein said electron collector is a metal selected from a group consisting of aluminium (AI), titanium (Ti), copper (Cu), lithium (Li) and combinations thereof.

8. The electrode according to claim 7, wherein said electron collector is aluminium foil.

9. The electrode according to any one of the preceding claims, wherein said electrode further comprises a dispersant and/or a non-conductive binder.

10. An energy storage device comprising an electrode according to any one of claims 1-9.

11. The energy storage device according to claim 10, wherein said electrode is a cathode.

12. The energy storage device according to claim 10 or 11, further comprising LiPF₆ as electrolyte solution and an anode comprising an alkali metal.

13. An electrode slurry composition for manufacturing an electrode for use in an energy storage device, said electrode slurry composition comprising an active material and a conductive binder, wherein said conductive binder comprises a solution-processed n-type conducting polymer having conductivity of at least 100 S/cm.

14. The electrode slurry composition according to claim 13, wherein said n-type conducting polymer is side-chain free.

15. The electrode slurry composition according to claim 13 or 14, wherein said solution-processed n-type conducting polymer comprises a repeating unit comprising a central symmetrical benzene ring as the skeleton, active hydrogen and at least one electron-withdrawing group at the benzylic position.

16. The electrode slurry composition according to any one of claims 13-15, wherein said solution-processed n-type conducting polymer is poly(benzodifurandione) (PBFDO), poly[(2,2′-(2,5-dihydroxy-1,4-phenylene)diacetic acid)-co-3,7-dihydrobenzo[1,2-b:4,5-b′]difuran-2,6-dione](PDADF), poly[(2,2′-(2,5-dihydroxy-1,4-phenylene)diacetic acid) (PDADF-P) or a mixture thereof.

17. The electrode slurry composition according to any one of claims 13-16, wherein said active material is selected from the group consisting of: LiVOPO₄, LiCoO₂, LiNiO₂, LiNi₁₋ₙCoₙO₂, LiNi₁₋ₙ₋ₘCOₙAlₘO₂, LiNi₁₋ₙ₋ₘCOₙMnₘO₂, LiMn₂O₄, LiFePO₄ and LiFe₁₋ₙMnₙPO₄, LiCoPO₄, Li₂FeP₂O₇, Li₂FeSiO₄ and combinations thereof.

18. The electrode slurry composition according to any one of the claims 13-17, wherein said active material is present in an amount of from 50 to 98 wt %.

19. The electrode slurry composition according to any one of the claims 13-18, wherein said conductive binder in present in the composition in the amount from 0.1 to 25 wt %, preferably from 0.2 to 10 wt %, most preferably from 0.5 to 5 wt %.

20. The electrode slurry composition according to any one of claims 13-19, wherein said electrode slurry composition has solid content of from 10 to 50%.

21. A method for manufacturing an electrode for use in an energy storage device, said method comprising the steps of:
a) mixing an active material with a dispersion solution comprising a conductive binder comprising a solution-processed n-type conducting polymer having conductivity of at least 100 S/cm, thus obtaining a slurry;
b) applying said slurry onto an electron collector thus obtaining said electrode
c) drying said electrode.

22. The method according to claim 21, said method further comprising the step of:
d) homogenizing said slurry;
wherein said step d) occurs before step b).

23. The method according to any one of claims 21 or 22, wherein said step b) is performed by means of bar coating.

24. The method according to any one of claims 21-23, wherein step c) is performed at the temperature of from 100° C. to 200° C. and for a period of time from 30 min to 2 h.

25. The method according to any one of claims 21-24, wherein said step d) is performed for a period of time from 1 min to 1 h at 4000-10000 rpm.
